(19) United States
(12) Patent Application Publication
(10) Pub. No.: US 2006/0181896 A1
(43) Pub. Date: Aug. 17, 2006

(54) Fiber-glow floormats

(76) Inventor: Michael Chen Lin, New Braunfels, TX (US)

Correspondence Address: Michael Chen Lin, 435 East Tanglewood Dr., New Braunfels, TX, 78130, US

(21) Appl. No.: 11/058,119

(22) Filed: Feb. 15, 2005

(51) Int. Cl. G02B 6/04

(52) U.S. Cl. 362/554; 362/488

(57) ABSTRACT

This floormat is different from others floormats available because the use of optical fibers. Fiber optic cables are placed in the channels of the floormat and are connected to an onboard battery charged light box that can be turned on or off by a rocker switch. This creates a soft glowing light design at night.

### CROSS-REFERENCE TO RELATED APPLICATIONS

U.S. Patent Documents

| | | |
|---|---|---|
| 4,517,631 | May 14, 1985 | Mullins |
| 5,134,550 | Jul. 28, 1992 | Young |
| 5,517,390 | May 14, 1996 | Zins |
| 5,576,078 | Nov. 19, 1996 | Schatz |
| 5,876,107 | Mar. 2, 1999 | Parker |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable.

### BACKGROUND OF THE INVENTION

A. Field of Endeavor

The present invention is related to aesthetic fiber optic illumination technologies.

B. Description of Information

Optical fibers are widely used in illumination and communications. An optical fiber is highly flexible, transparent, and is a light conductive material consists of a core surrounded by protective sheath.

### BRIEF SUMMARY OF THE INVENTION

This new automobile floormat uses fiber optic cables to provide illumination. Fiber optic cables are being heat pressed in to the channels of the floormat and is connected to an onboard battery charged light box which can be turned on or off by a rocker switch. The light box consist of reflective panels and an LED light powered by two replaceable batteries. This floormat will provide drivers and passengers with better vision and a pleasing view at night when entering or exiting their vehicle. Most importantly, it will function as same as other automobile floormats.

### BRIEF DESCRIPTION OF THE SEVERAL VIEWS OF THE DRAWING

FIG. 1 is a top view of the Fiber-Glow Floormat with fiber optic cable and a light box.

FIG. 2 is a top view of the light box with an opening for replacing batteries and LED light bulb.

FIG. 3 is a right side view of the light box (on FIG. 2) with rocker switch (left) and a fiber optic cable (right).

FIG. 4A is a view of thin optical fibers bundled in a clear sheath to form a cable.

FIG. 4B is a view of a single optic fiber with its diameter equal to the sheath on FIG. 4A.

FIG. 4C is a cross-sectional view of the fiber optic cable in the channel of the floormat.

FIG. 5 is a top inner view of the light box. It clearly identifies the two fiber optic cables, batteries, an LED light and a rocker switch.

FIG. 6 is a view like FIG. 5 but with an extra fiber optic cable placed in the center of the light box for lighted designs in the center of the floormat.

### DETAILED DESCRIPTION OF THE DRAWING

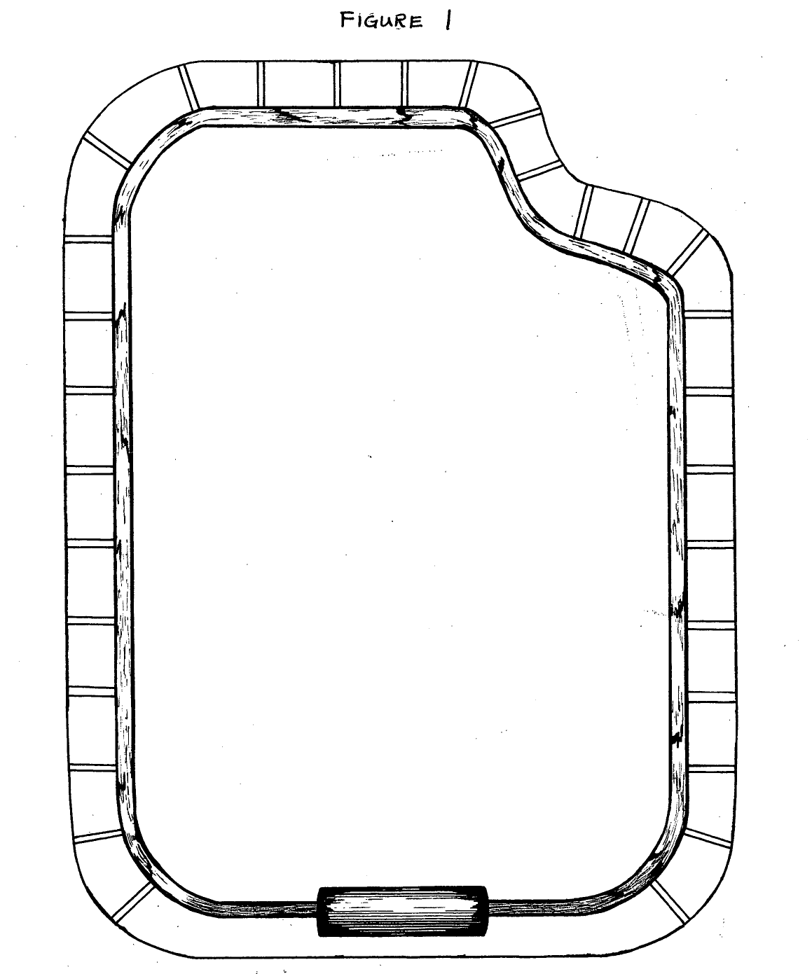

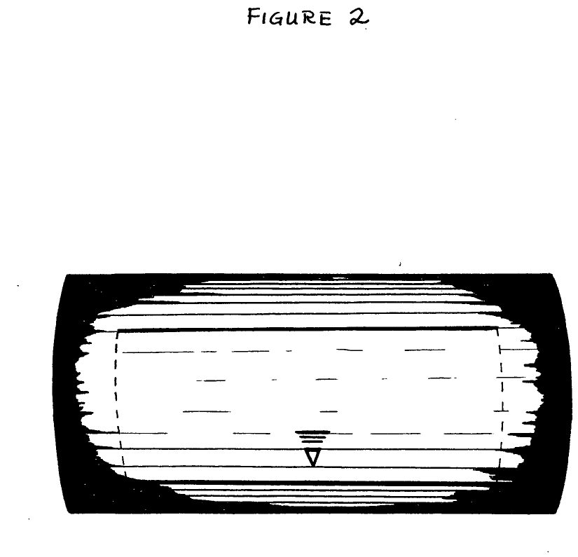

FIG. 1 is a completed fiber-glow floormat with a light box located on the bottom center and a fiber optic cable (There are two types of fiber optic cables available for illumination, side-glow fiber optics and end-glow fiber optics. In this invention side-glow fiber optic cables are being used) connected to both ends of the light box. FIG. 2 is a top view of the light box with an opening for replacing batteries and LED light bulb.

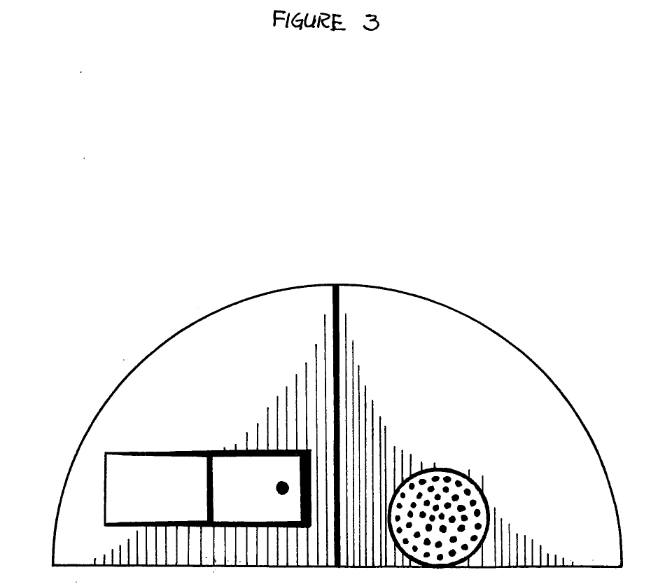

FIG. 3 is a right side view of the light box (on FIG. 2) with a rocker switch (left) and a fiber optic cable coming out of the light box (right).

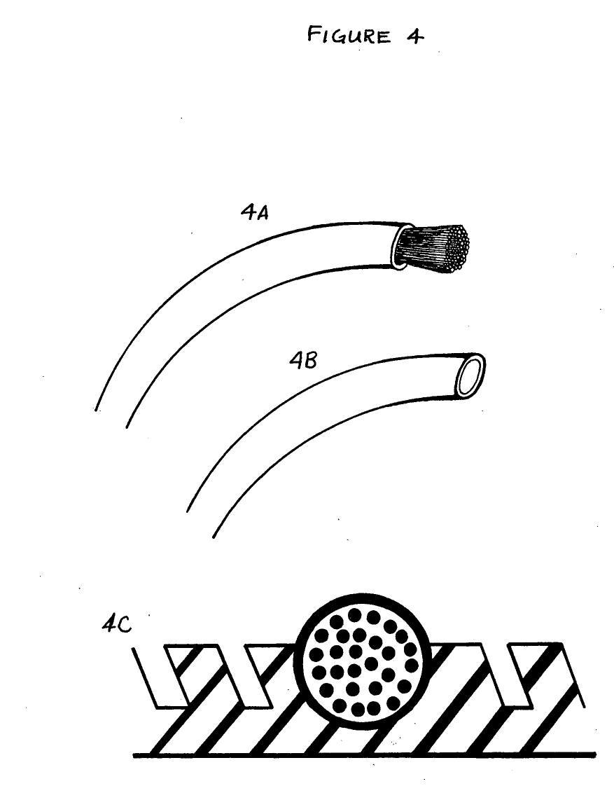

FIG. 4A is a view of thin optical fibers bundled in a clear sheath to form a cable and FIG. 4B is a view of a single optic fiber with its diameter equal to the sheath on FIG. 4A. A fiber optic bundled cable or a fiber optic cable will provide the same lighted design on the floormat.

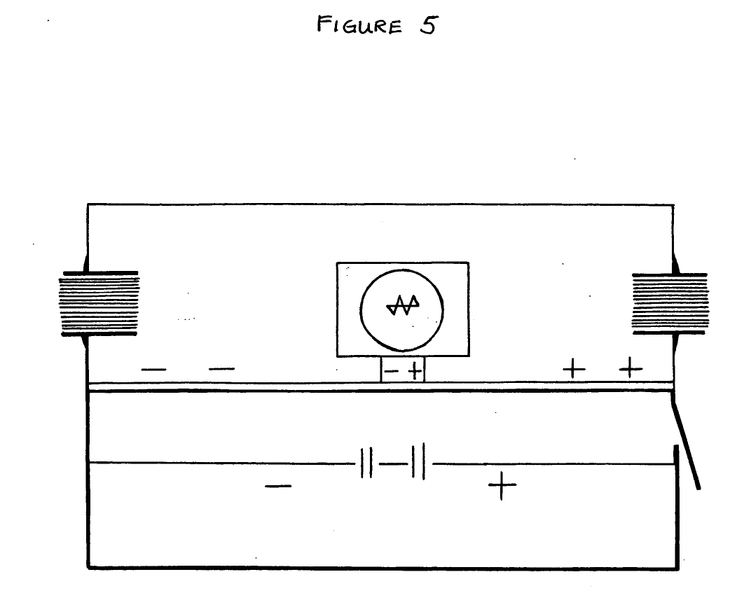

FIG. 4C is a cross-sectional view of the fiber optic cable in the channel of the floormat. The fiber optic cable is heat pressed on to the floormat's channel. FIG. 5 is a top inner view of the light box It clearly identifies the two fiber optic cables, batteries, an LED light and a rocker switch. The LED side of the light box is placed with reflective panels.

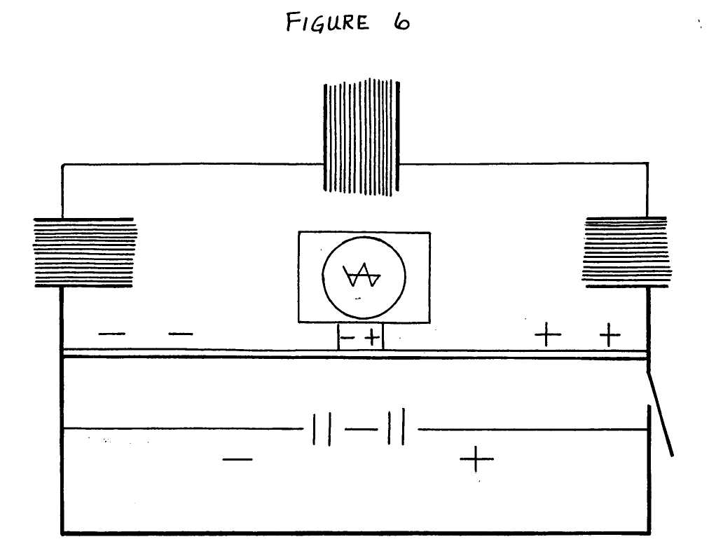

FIG. 6 is a top inner view like FIG. 5 but with an extra fiber optic cable placed in the center of the light box for lighted designs in the center of the floormat.

There are three parts needed to be made to create this fiber-glow floormat, first, a floormat manufactory has to create a floormat mold that will include channels that respect to the diameter of fiber cables and a space for the light box Second, fiber optic cables need to be purchased and shipped to the floormat manufactory. Third, light boxes need to be purchased and shipped to the floormat manufactory. Fiber optic cables and light boxes can be heat pressed on to the mats at the floormat manufactory. The purchaser of the floormat will need to install batteries in the light box and place it on the floor board of the automobile. The purchaser can turn on or off the light with the rocker switch when desired.

1. I claim that this invention will use optical fibers to provide illumination on automobile floormats.

2. I claim that this invention has an onboard battery charged light box which lights up the fiber optic cables.
